(19) United States
(12) Patent Application Publication
(10) Pub. No.: US 2021/0286983 A1
(43) Pub. Date: Sep. 16, 2021

(54) ESTIMATION METHOD, AND COMPUTER-READABLE RECORDING MEDIUM RECORDING ESTIMATION PROGRAM

(71) Applicant: FUJITSU LIMITED, Kawasaki-shi (JP)

(72) Inventors: Takuya Sato, Yokohama (JP); Shoichi Masui, Sagamihara (JP)

(73) Assignee: FUJITSU LIMITED, Kawasaki-shi (JP)

(21) Appl. No.: 17/335,143

(22) Filed: Jun. 1, 2021

Related U.S. Application Data
(63) Continuation of application No. PCT/JP2018/045976, filed on Dec. 13, 2018.

(51) Int. Cl. G06K 9/00; G06T 7/73; A63B 24/00; G06N 20/00

(52) U.S. Cl. CPC G06K 9/00342; G06K 9/00369; G06T 2207/30196; A63B 24/0062; G06N 20/00; G06T 7/73

(57) ABSTRACT

An estimation method in which a computer executes processing includes: acquiring a first distance image that includes information regarding a distance from a sensor to a first subject; estimating three-axis polar coordinates data of the first subject from an acquired first distance image using a prediction model for posture recognition that has learned three-axis polar coordinates data based on a spine vector that corresponds to a spine of a second subject and a shoulder vector that corresponds to a line that connects both shoulders of the second subject that are generated on the basis of coordinate data that represents a position of the second subject and a second distance image based on the coordinate data of the second subject and the distance from the sensor; and estimating a posture of the first subject on the basis of the three-axis polar coordinates data of the first subject.

### CROSS-REFERENCE TO RELATED APPLICATION

This application is a continuation application of International Application PCT/JP2018/045976 filed on Dec. 13, 2018 and designated the U.S., the entire contents of which are incorporated herein by reference.

### FIELD

The embodiments discussed herein are related to an estimation method, an estimation program, and an estimation device.

### BACKGROUND

Traditionally, there has been a device that recognizes a posture and a movement of a person on the basis of a distance image (hereinafter, also referred to as depth image) output from a distance sensor (hereinafter, also referred to as depth sensor) that measures a distance to a person. The device extracts a skeletal model having a three-dimensional skeleton position, for example, on the basis of a distance image output from one distance sensor. Thereafter, the device specifies a motion of the person on the basis of the extracted skeletal model.

U.S. Patent Application Publication No. 2010/0197390, Japanese Laid-open Patent Publication No. 2017-119102, and International Publication Pamphlet No. WO 2017/187641 are disclosed as related art.

M. Kitagawa and B. Windser, “MoCap for Artists”, Elsevier/Focal Press, 2008, pp. 188-193, Yuji Oshima et al., “Three-dimensional dynamics focusing on lower trunk motion in the horizontal plane during sprinting”, Japan Journal of Physical Education, Health and Sport Sciences, vol. 61, no. 1, p. 115-131, June 2016, Shuta HASEGAWA et al. “Proposal and evaluation of device operation using hand gestures considering posture”, IPSJ SIG Technical Report, vol. 2012-HCI-147, no. 24, p. 1-6, March 2012 are disclosed as related art.

### SUMMARY

According to an aspect of the embodiments, an estimation method in which a computer executes processing includes: acquiring a first distance image that includes information regarding a distance from a sensor to a first subject; estimating three-axis polar coordinates data of the first subject from an acquired first distance image using a prediction model for posture recognition that has learned three-axis polar coordinates data based on a spine vector that corresponds to a spine of a second subject and a shoulder vector that corresponds to a line that connects both shoulders of the second subject that are generated on the basis of coordinate data that represents a position of the second subject and a second distance image based on the coordinate data of the second subject and the distance from the sensor; and estimating a posture of the first subject on the basis of the three-axis polar coordinates data of the first subject.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a configuration of an estimation system according to a first embodiment;

FIG. 2 is a diagram illustrating an example of a rotation axis and an inverted axis;

FIG. 3 is a diagram illustrating an example of angles of a rotation axis and an inverted axis;

FIG. 4 is a diagram illustrating an example of a posture of a person who is hardly expressed in a case where the rotation axis and the inverted axis are used;

FIG. 5 is a block diagram illustrating an example of a configuration an estimation device according to the first embodiment;

FIG. 6 is a diagram illustrating an example of a spine vector and a shoulder vector in three-axis polar coordinates;

FIG. 7 is a diagram illustrating an example of Euler angle expression;

FIG. 8 is a diagram illustrating an example of comparison between three-axis polar coordinates expression and Euler angle expression;

FIG. 9 is a diagram illustrating an example of a scoring assistance screen;

FIG. 10 is a flowchart illustrating an example of learning processing according to the first embodiment;

FIG. 11 is a flowchart illustrating an example of estimation processing according to the first embodiment;

FIG. 12 is a block diagram illustrating an example of a configuration of an estimation device according to a second embodiment;

FIG. 13 is a diagram illustrating an example of an analysis result storage unit;

FIG. 14 is a diagram illustrating another example of the scoring assistance screen;

FIG. 15 is a flowchart illustrating an example of estimation processing according to the second embodiment;

FIG. 16 is a flowchart illustrating an example of the number of times of somersault determination processing;

FIG. 17 is a flowchart illustrating an example of the number of times of twist determination processing; and

FIG. 18 is a diagram illustrating an example of a computer that executes an estimation program.

### DESCRIPTION OF EMBODIMENTS

To assist judges and strengthen athletes in scoring assistance competitions such as the gymnastics, establishment of a technique for recognizing three-dimensional complex movements of a skeleton of an athlete is required. A posture of a person is detected from a distance image, and skeleton recognition is performed by using a prediction model for skeleton recognition according to the posture of the person and the distance image. In traditional detection of the posture of the person, the posture of the person has been detected using two axes including a rotation axis that represents a direction of a line connecting both shoulders in the rotation direction and an inverted axis representing a direction of the spine in the forward roll direction. However, in a case where these two axes are used, a cartwheel direction of the person is not determined. Furthermore, when the person falls sideways, if the left and right shoulders are projected on a horizontal plane, the left and right shoulders overlap. Therefore, a component of a vector is eliminated, and an angle in the rotation direction is not obtained. Therefore, it is difficult to estimate the posture reflecting somersaults and twists in which these postures exist.

One aspect provides an estimation method, an estimation program, and an estimation device that estimate a posture reflecting somersaults and twists.

Hereinafter, embodiments of an estimation method, an estimation program, and an estimation device disclosed in the present application will be described in detail with reference to the drawings. Note that the present embodiment does not limit the disclosed technology. Furthermore, the following embodiments may be appropriately combined in a range where no inconsistency occurs.

### First Embodiment

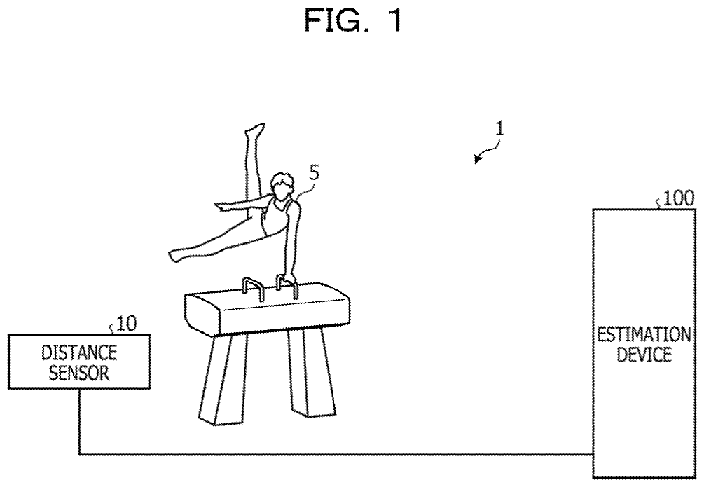

FIG. 1 illustrates an example of a configuration of an estimation system according to a first embodiment. An estimation system 1 illustrated in FIG. 1 includes a distance sensor 10 and an estimation device 100. Note that the number of distance sensors 10 in the estimation system 1 is not limited, and any number of distance sensors 10 may be included. The distance sensor 10 and the estimation device 100 are communicably connected to each other in a wired or wireless manner.

The estimation system 1 is an example of a system that measures a person 5 who is a subject with the distance sensor 10 and estimates a posture or the like of the person 5 by the estimation device 100 on the basis of a measurement result.

For example, the distance sensor 10 measures (senses) a distance to an object using an infrared laser or the like for each pixel and outputs a distance image. The distance image includes a distance to each pixel. That is, for example, the distance image is a depth image representing a depth of the subject viewed from the distance sensor (depth sensor) 10. The distance sensor 10 measures, for example, a distance to an object (subject) at a distance up to about 15 m. In the present embodiment, the object is the person 5.

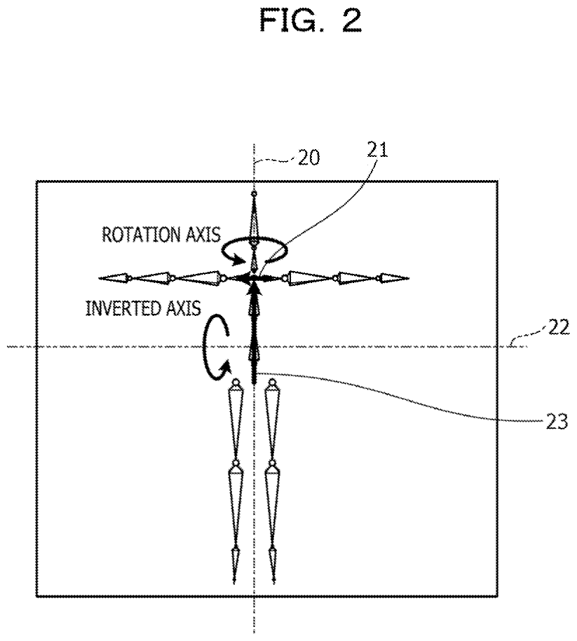

Here, with reference to FIGS. 2 to 4, detection of a posture of a person in a case where two axes including a rotation axis and an inverted axis are used will be described. Note that, in the following description, the detection of the posture of the person is also referred to as posture recognition. FIG. 2 is a diagram illustrating an example of a rotation axis and an inverted axis. As illustrated in FIG. 2, a posture of a person can be represented using a vector 21 corresponding to a rotation axis 20 and a vector 23 corresponding to an inverted axis 22. At this time, the rotation axis 20 represents a direction in a rotation direction of a line connecting the right shoulder and the left shoulder of the person. Furthermore, the inverted axis 22 represents a direction in a forward roll direction of the spine. In a case where the two axes are used in this way, a straight line connecting two joints (vectors 21 and 23) is projected on a plane to be a reference, and a posture is classified based on a size of an angle formed by the straight line and a straight line to be a reference on the plane.

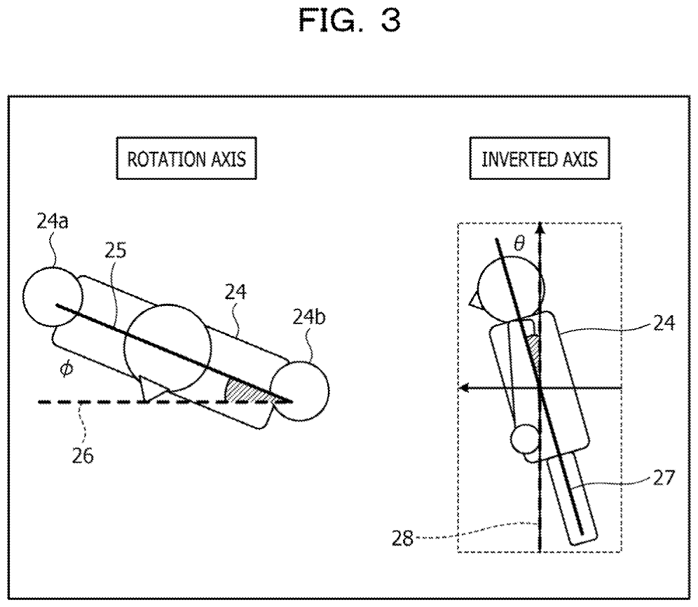

FIG. 3 is a diagram illustrating an example of angles of a rotation axis and an inverted axis. As illustrated in FIG. 3, in order to obtain an angle φ of the rotation axis, a line segment 25 connecting a right shoulder 24a and a left shoulder 24b of a person 24 is projected on a horizontal plane (cross section) in a camera coordinate system. Next, on the horizontal plane on which the line segment 25 is projected, an angle φ formed by a reference line 26 and the projected line segment 25 is obtained. Furthermore, in order to obtain an angle θ of the inverted axis, a spine line 27 extending a line segment that connects two points on the spine is projected on a plane perpendicular to a plane including the line segment 25 and a straight line in the vertical direction in the camera coordinate system. Next, on the plane on which the line segment 25 is projected, the angle θ formed by a reference line 28 and a projected spine line 27 is obtained. In a case of an estimation device using two axes, posture recognition is performed using the angles φ and θ.

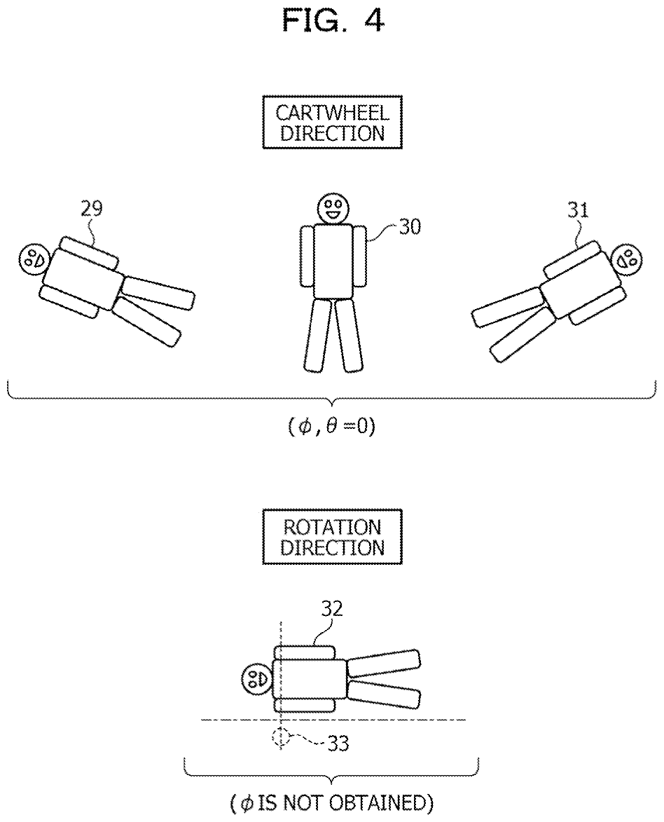

FIG. 4 is a diagram illustrating an example of a posture of a person who is hardly expressed in a case where the rotation axis and the inverted axis are used. As illustrated in FIG. 4, in a case of the estimation device using two axes, because all angles φ and θ are the same values (=0), postures 29, 30, and 31 in a cartwheel direction of a person are not distinguished. Furthermore, in a case of the estimation device using two axes, in a posture 32, when the left and the right shoulders are projected on the horizontal plane, the left and the right shoulders overlap as indicated by a shadow 33. Therefore, components of the vectors are eliminated, and an angle φ in the rotation direction is not obtained. Note that, in a case of a posture close to the posture 32, because the vector component decreases, the angle φ is easily fluctuated. In other words, for example, in a case where two axes including the rotation axis and the inverted axis are used, it is difficult to express postures that reflect somersaults and twists in which postures 29 to 32 exist.

Returning to the description of FIG. 1, the estimation device 100 recognizes a posture or the like of the person 5 on the basis of the distance image input from the distance sensor 10. The estimation device 100 acquires a first distance image including information regarding a distance from the distance sensor 10 to the person 5 who is a first subject. The estimation device 100 estimates three-axis polar coordinates data of the first subject from the acquired first distance image using a prediction model for posture recognition that has learned three-axis polar coordinates data of a second subject that is a person at the time of learning a prediction model for posture recognition and a second distance image. Here, the three-axis polar coordinates data of the second subject is three-axis polar coordinates data based on a spine vector corresponding to the spine of the second subject and a shoulder vector corresponding to a line that connects both shoulders of the second subject that have been generated on the basis of coordinate data representing a position of the second subject. Furthermore, the second distance image is a distance image based on the coordinate data representing the position of the second subject and the distance from the distance sensor 10. The estimation device 100 estimates the posture of the person 5 on the basis of the three-axis polar coordinates data of the person 5. As a result, the estimation device 100 can estimate a posture reflecting somersaults and twists.

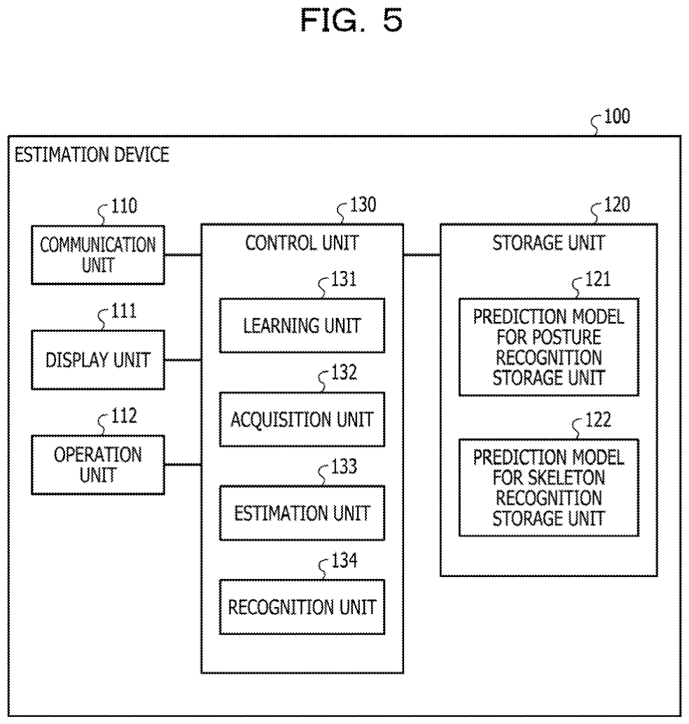

Next, a functional configuration of the estimation device 100 will be described with reference to FIG. 5. FIG. 5 is a block diagram illustrating an example of a configuration of an estimation device according to the first embodiment. As illustrated in FIG. 5, the estimation device 100 includes a communication unit 110, a display unit 111, an operation unit 112, a storage unit 120, and a control unit 130. Note that the estimation device 100 may include various functional units included in a known computer, for example, functional units such as various input devices, audio output devices, or the like, in addition to the functional units illustrated in FIG. 5. As an example of the estimation device 100, a portable personal computer or the like can be adopted. Note that, for the estimation device 100, not only the portable personal computer described above but also a stationary personal computer can be adopted.

The communication unit 110 is implemented by, for example, a network interface card (NIC) or the like. The communication unit 110 is a communication interface that is wiredly or wirelessly connected to the distance sensor 10 and controls information communication with the distance sensor 10.

The display unit 111 is a display device to display various types of information. The display unit 111 is implemented by, for example, a liquid crystal display or the like as a display device. The display unit 111 displays various screens such as a display screen input from the control unit 130.

The operation unit 112 is an input device that receives various operations from a user of the estimation device 100. The operation unit 112 is implemented by, for example, a keyboard, a mouse, or the like as an input device. The operation unit 112 outputs an operation input by the user to the control unit 130 as operation information. Note that the operation unit 112 may be implemented by a touch panel or the like as an input device, and the display device of the display unit 111 and the input device of the operation unit 112 may be integrated.

The storage unit 120 is implemented by, for example, a storage device such as a semiconductor memory element such as a random access memory (RAM), a flash memory, or the like, a hard disk, an optical disk, or the like. The storage unit 120 includes a prediction model for posture recognition storage unit 121 and a prediction model for skeleton recognition storage unit 122. Furthermore, the storage unit 120 stores information used for processing by the control unit 130.

The prediction model for posture recognition storage unit 121 stores prediction model information that is used when a posture of the person 5 who is the first subject in the first distance image is determined. The prediction model for posture recognition storage unit 121 stores, for example, a prediction model for posture recognition that is a learned model that has performed machine learning on a distance image of a person who is the second subject and the three-axis polar coordinates data in association with each other. Note that the prediction model for posture recognition may be a learned model that has performed machine learning on the distance image of the person who is the second subject and a posture number obtained by classifying the three-axis polar coordinates data in association with each other. As an algorithm of machine learning, for example, random forest and deep learning can be used.

The prediction model for skeleton recognition storage unit 122 stores prediction model information indicating a hypothetical joint position (skeleton position) for each recognition result of the posture recognition. As the recognition result of the posture recognition, for example, the three-axis polar coordinates data or the posture number obtained by classifying the three-axis polar coordinates data can be used. The prediction model for skeleton recognition storage unit 122 associates, for example, a posture number, a distance image corresponding to the posture number, and information regarding the joint position of the person (prediction model information for skeleton recognition). Although not illustrated, it is assumed that the prediction model information for skeleton recognition corresponding to each posture number exist respectively. Note that the prediction model for skeleton recognition storage unit 122 is generated by performing machine learning about the three-axis polar coordinates data, the distance image, and the information regarding the joint position. Furthermore, the prediction model for skeleton recognition storage unit 122 may be generated by performing machine learning about various distance images corresponding to the posture number and the information regarding the joint position of the person. In this case, as an algorithm of machine learning, for example, random forest and deep learning can be used.

The control unit 130 is implemented, for example, by executing a program stored in an internal storage device by a central processing unit (CPU), a graphics processing unit (GPU), a micro processing unit (MPU), or the like using a RAM as a working region. Furthermore, the control unit 130 may be implemented by, for example, an integrated circuit such as an application specific integrated circuit (ASIC), a field programmable gate array (FPGA), or the like.

The control unit 130 includes a learning unit 131, an acquisition unit 132, an estimation unit 133, and a recognition unit 134 and realizes or executes functions and actions of information processing to be described below. In other words, for example, each processing unit of the control unit 130 executes learning processing and estimation processing. Note that an internal configuration of the control unit 130 is not limited to the configuration illustrated in FIG. 5 and may be another configuration as long as the configuration executes the information processing described later.

Regarding a person who is the second subject to be learned, the learning unit 131 learns three-axis polar coordinates data representing a posture of the person and a distance image and generates a prediction model for posture recognition. For example, the learning unit 131 may acquire coordinate data generated by motion capturing the person who is the second subject from an information processing device for motion capturing (not illustrated). For example, the learning unit 131 may acquire coordinate data of the person who is the second subject generated using computer graphics (CG) from an information processing device for CG data creation. The acquired coordinate data is coordinate data representing a position of the person who is the second subject on three axes including the x, y, and z axes.

The learning unit 131 calculates a spine vector from two joints on the spine of the person who is the second subject on the basis of the acquired coordinate data. The learning unit 131 calculates an angle θ formed by the y axis and the calculated spine vector. The learning unit 131 projects the spine vector on an xz plane and calculates an angle φ formed by the spine vector and the z axis.

The learning unit 131 calculates a shoulder vector from two joints of the right shoulder and the left shoulder of the person who is the second subject on the basis of the acquired coordinate data. The learning unit 131 obtains a rotation matrix such that the spine vector overlaps the y axis. The learning unit 131 rotates the shoulder vector using the obtained rotation matrix. The learning unit 131 projects the rotated shoulder vector on the xz plane and calculates an angle ξ formed by the shoulder vector and the x axis. In other words, for example, the learning unit 131 calculates three-axis polar coordinates data having the angles θ, φ, ξ and as components.

The learning unit 131 calculates a distance of the person who is the second subject for each pixel of the distance image in a case where the distance sensor 10 is assumed, on the basis of the acquired coordinate data. The learning unit 131 generates the second distance image on the basis of the acquired coordinate data and the calculated distance from the distance sensor 10 for each pixel. That is, for example, the second distance image is a distance image in a case where it is assumed that the person who is the second subject to be learned be measured by the distance sensor 10.

The learning unit 131 learns the generated second distance image and the calculated three-axis polar coordinates data and generates a prediction model for posture recognition. The learning unit 131 stores the generated prediction model for posture recognition in the prediction model for posture recognition storage unit 121.

In other words, for example, the learning unit 131 learns the three-axis polar coordinates data of the second subject or the posture number obtained by classifying the three-axis polar coordinates data and the second distance image and generates the prediction model for posture recognition. Here, the three-axis polar coordinates data of the second subject is three-axis polar coordinates data based on a spine vector corresponding to the spine of the second subject and a shoulder vector corresponding to a line that connects both shoulders of the second subject that have been generated on the basis of coordinate data representing a position of the second subject. Furthermore, the second distance image is a distance image based on the coordinate data representing the position of the second subject and the distance from the distance sensor 10.

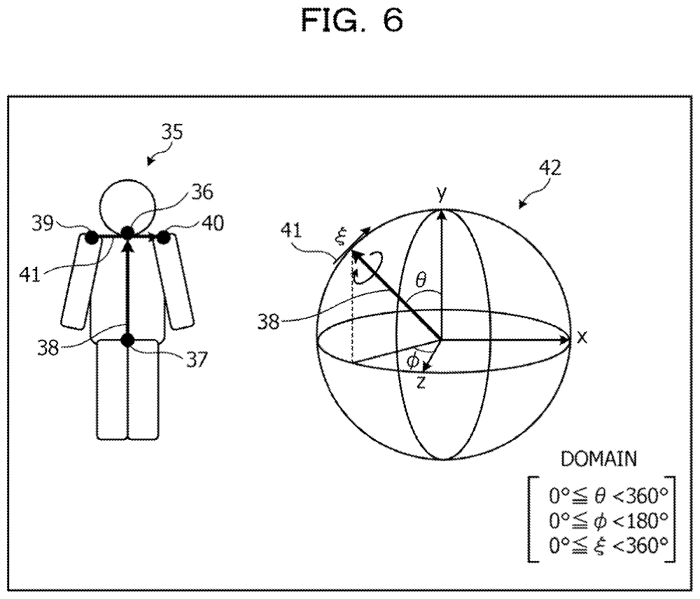

Here, with reference to FIGS. 6 to 8, three-axis polar coordinates expression of the three-axis polar coordinates data will be described. FIG. 6 is a diagram illustrating an example of a spine vector and a shoulder vector in the three-axis polar coordinates. As illustrated in FIG. 6, it is assumed that a line segment connecting a cervical spine 36 and a lumbar spine 37 of a person 35 be a spine vector 38. Furthermore, it is assumed that a line segment connecting a right shoulder 39 and a left shoulder 40 of the person 35 be a shoulder vector 41. In three-axis polar coordinates expression 42 according to the present embodiment, a posture of a person is represented using three angles including directions (θ, φ) of the spine vector 38 and rotation (ξ) of the shoulder vector 41. Note that, in a case where the person is upright in front of the distance sensor 10, it is assumed that all the angles θ, φ, and ξ be 0° (zero degrees). Furthermore, it is assumed that domains be respectively 0°≤θ<360°, 0°≤φ<180°, and 0°≤ξ<360°.

That is, for example, the three-axis polar coordinates expression 42 copes with a cartwheel of the person by dividing a value of the spine vector 38 into an inclined direction and an inclined amount. Furthermore, the three-axis polar coordinates expression 42 copes with a posture at which a person falls sideways by setting an axis when the direction of the shoulder vector 41 is calculated as the spine. When this is applied to gymnastics, the angle θ indicates a rotation component at the time when a somersault is performed, and the angle ξ indicates a rotation component at the time when a twist is performed. In other words, for example, the spine vector 38 represents an inclined direction and an inclined amount of the second subject, and the shoulder vector 41 represents the rotation direction of the second subject around the spine vector 38 as an axis.

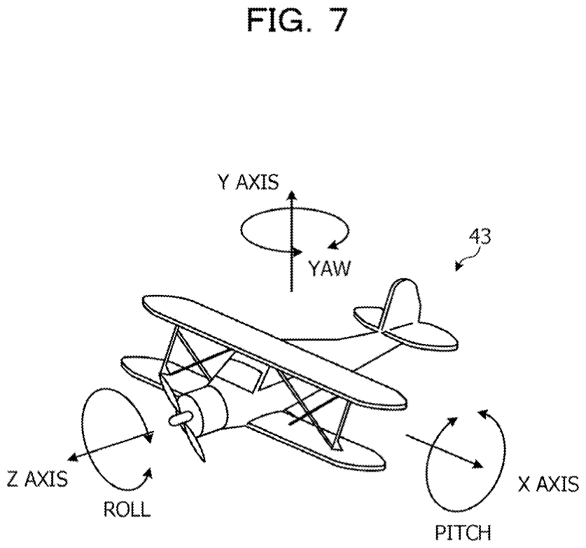

FIG. 7 is a diagram illustrating an example of Euler angle expression. Euler angle expression 43 illustrated in FIG. 7 uses the Cartesian coordinate system that is generally adopted in typical animation software. The Euler angle expression 43 expresses a three-dimensional joint angle using a pitch that is a rotation angle around the x axis, a yaw that is a rotation angle around the y axis, and a roll that is a rotation angle around the z axis.

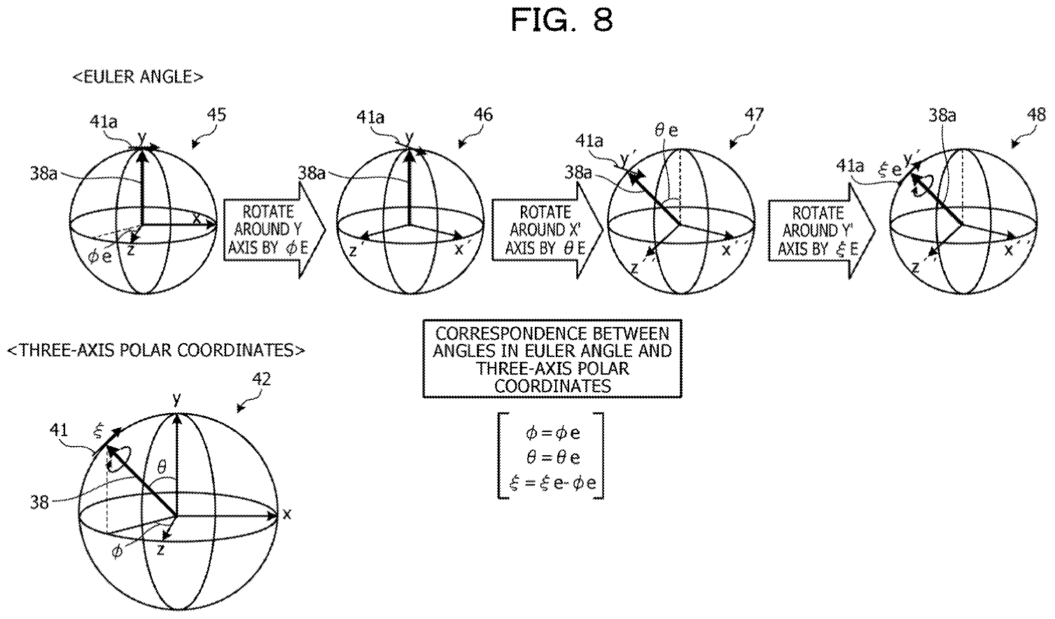

FIG. 8 is a diagram illustrating an example of comparison between three-axis polar coordinates expression and Euler angle expression. In FIG. 8, rotations of the x axis, the y axis, and the z axis in a case where a posture same as the three-axis polar coordinates expression 42 is represented by the Euler angle expression are illustrated. First, in Euler angle expression 45 that is an initial value, it is assumed that a spine vector 38a overlap the y axis and a shoulder vector 41a be parallel to the x axis. Next, the Euler angle expression 45 is rotated by φe around the y axis to be Euler angle expression 46. That is, for example, in the Euler angle expression 46, a reference of ξe is rotated by φe. At this time, the x axis is changed to an x′ axis, and the z axis is changed to a z′ axis. Moreover, the Euler angle expression 46 is rotated by θe around the x′ axis to be Euler angle expression 47. At this time, the x′ axis is changed to an x″ axis, the y axis is changed to a y′ axis, and the z′ is changed to a z″ axis. Moreover, the Euler angle expression 47 is rotated by ξe around the y′ axis to be Euler angle expression 48.

The spine vector 38a and the shoulder vector 41a in the Euler angle expression 48 are respectively equal to the spine vector 38 and the shoulder vector 41 in the three-axis polar coordinates expression 42. The correspondence of the respective angles in the three-axis polar coordinates expression 42 and the Euler angle expression 48 are φ=φe, θ=θe, and ξ=ξe−φe. In gymnastics, because φe changes from moment to moment as the person moves, it is not possible to estimate a twist rotation amount using only ξe. Furthermore, ξ=ξe is not satisfied because, in the three-axis polar coordinates expression 42, the direction of the distance sensor 10 is defined as ξ=0°, and a reference of 0° is different from than in the Euler angle expression 48. Therefore, in a case where a somersault and a twist motion in the gymnastics are recognized, it can be said that the three-axis polar coordinates expression 42 is better than the Euler angle expression 48.

Returning to the description of FIG. 5, the acquisition unit 132 starts acquisition by receiving a distance image from the distance sensor 10 via the communication unit 110. The acquisition unit 132 outputs the acquired distance image to the estimation unit 133 as the first distance image. In other words, for example, the acquisition unit 132 starts to acquire the first distance image including information regarding the distance from the distance sensor 10 to the first subject.

When the first distance image is input from the acquisition unit 132, the estimation unit 133 refers to the prediction model for posture recognition storage unit 121 and estimates the three-axis polar coordinates data of the person 5 who is the first subject using the prediction model for posture recognition. That is, for example, the estimation unit 133 recognizes the posture of the person 5. The estimation unit 133 outputs the first distance image and the estimated three-axis polar coordinates data to the recognition unit 134.

In other words, for example, the estimation unit 133 estimates the three-axis polar coordinates data of the first subject from the acquired first distance image, using the prediction model for posture recognition. Furthermore, the estimation unit 133 estimates a posture of the first subject on the basis of the three-axis polar coordinates data of the first subject. Furthermore, the estimation unit 133 outputs data regarding the estimated posture to skeleton recognition processing for recognizing a skeleton of the first subject using a prediction model for skeleton recognition selected on the basis of the estimated posture.

When the first distance image and the estimated three-axis polar coordinates data are input from the estimation unit 133, the recognition unit 134 refers to the prediction model for skeleton recognition storage unit 122 and selects the prediction model for skeleton recognition on the basis of the estimated three-axis polar coordinates data. The recognition unit 134 determines a three-dimensional position of the skeleton of the person 5 who is the first subject on the basis of the first distance image using the prediction model for skeleton recognition selected by the prediction model for skeleton recognition storage unit 122 and generates skeleton information indicating the posture of the person 5. That is, for example, the recognition unit 134 recognizes the skeleton of the person 5 who is the first subject. The recognition unit 134 displays the recognized skeleton information, for example, by outputting the skeleton information to the display unit 111. For example, the recognition unit 134 outputs an angle of each joint to the display unit 111 on the basis of the recognized skeleton information and makes the display unit 111 display the output angle. Furthermore, the recognition unit 134 may transmit an image of the recognized skeleton information and the angle of each joint to a terminal for a judge and display a scoring assistance screen on the terminal.

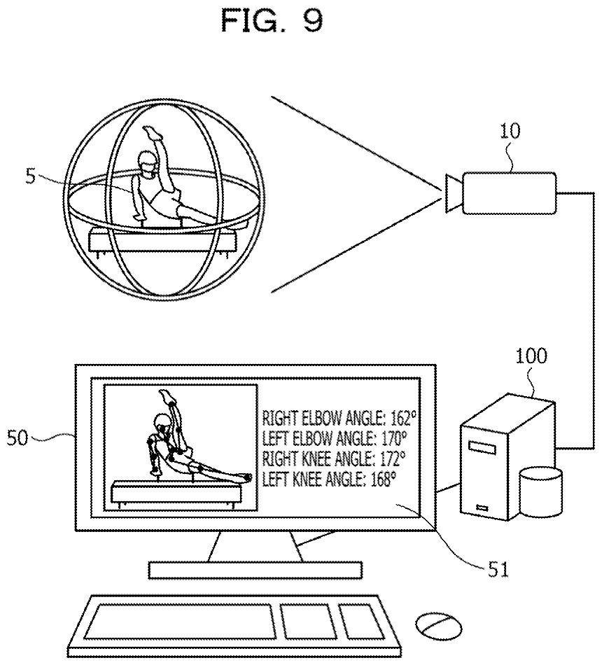

FIG. 9 is a diagram illustrating an example of a scoring assistance screen. As illustrated in FIG. 9, in a terminal for a judge 50, for example, the distance sensor 10 measures the person 5, the estimation device 100 receives skeleton information, and a scoring assistance screen 51 is displayed. Note that an angle of each joint may be displayed on the scoring assistance screen 51 on the basis of the skeleton information.

Note that the recognition unit 134 may output the generated skeleton information, for example, together with a distance image or a captured image captured by a camera, to a processing unit or a processing device that executes skeleton correction processing. That is, for example, the recognition unit 134 can output the generated skeleton information, for example, as a skeletal model, so as to be used for CG animation. Moreover, the recognition unit 134 may output the generated skeleton information to an external storage device (not illustrated) or the like, for example, by processing the skeleton information into a specific format. Note that the recognition unit 134 may generate a three-dimensional model on the basis of the generated skeleton information, and output the generated model to the display unit 111 and display the generated model on the display unit 111.

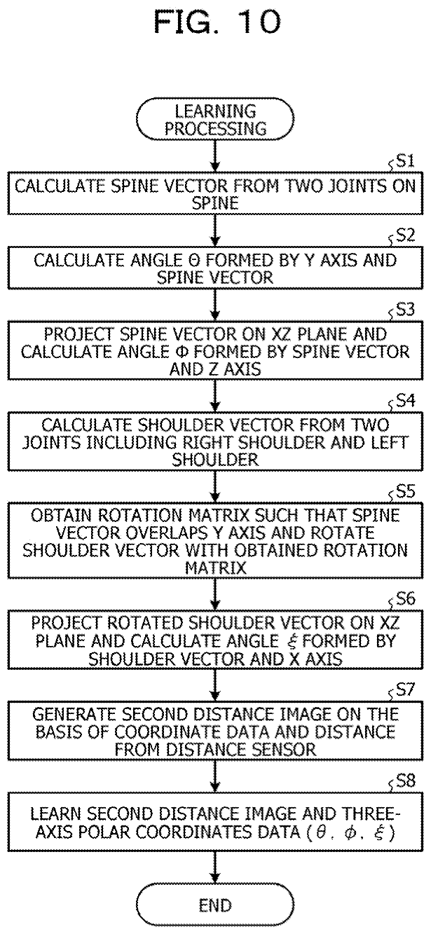

Next, an operation of the estimation device 100 according to the first embodiment will be described. First, the learning processing will be described with reference to FIG. 10. FIG. 10 is a flowchart illustrating an example of the learning processing according to the first embodiment.

The learning unit 131 acquires coordinate data generated by motion capturing or CG processing on the person who is the second subject from an information processing device for motion capturing or CG processing (not illustrated). The learning unit 131 calculates a spine vector from two joints on the spine of the person who is the second subject on the basis of the acquired coordinate data (step S1). The learning unit 131 calculates an angle θ formed by the y axis and the calculated spine vector (step S2). The learning unit 131 projects the spine vector on an xz plane and calculates an angle φ formed by the spine vector and the z axis (step S3).

The learning unit 131 calculates a shoulder vector from two joints of the right shoulder and the left shoulder of the person who is the second subject on the basis of the acquired coordinate data (step S4). The learning unit 131 obtains a rotation matrix such that the spine vector overlaps the y axis and rotates the shoulder vector with the obtained rotation matrix (step S5). The learning unit 131 projects the rotated shoulder vector on the xz plane and calculates an angle ξ formed by the shoulder vector and the x axis (step S6).

The learning unit 131 calculates a distance of the person who is the second subject for each pixel of the distance image in a case where the distance sensor 10 is assumed, on the basis of the acquired coordinate data. The learning unit 131 generates a second distance image on the basis of the acquired coordinate data and the calculated distance from the distance sensor 10 for each pixel (step S7).

The learning unit 131 learns the generated second distance image and the calculated three-axis polar coordinates data (θ, φ, ξ) and generates a prediction model for posture recognition (step S8). The learning unit 131 stores the generated prediction model for posture recognition in the prediction model for posture recognition storage unit 121. As a result, the estimation device 100 can generate a prediction model for posture recognition that has learned the three-axis polar coordinates data and the second distance image of the second subject.

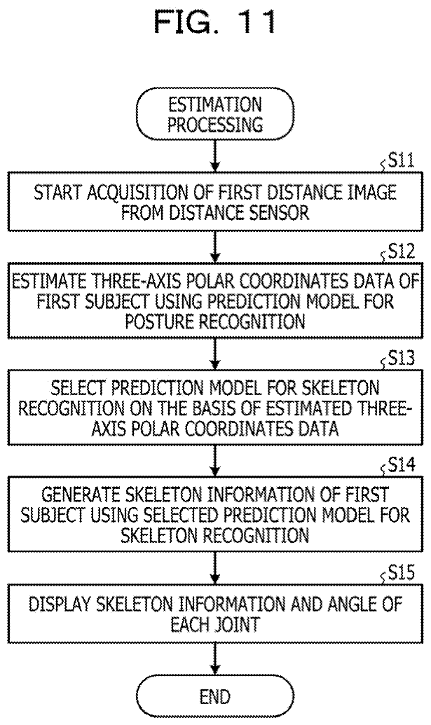

Subsequently, estimation processing for performing posture recognition on the first distance image acquired from the distance sensor 10 will be described. FIG. 11 is a flowchart illustrating an example of estimation processing according to the first embodiment.

The acquisition unit 132 receives a first distance image from the distance sensor 10 and starts acquisition (step S11). The acquisition unit 132 outputs the acquired first distance image to the estimation unit 133.

When the first distance image is input from the acquisition unit 132, the estimation unit 133 refers to the prediction model for posture recognition storage unit 121 and estimates the three-axis polar coordinates data of the person 5 who is the first subject using the prediction model for posture recognition (step S12). The estimation unit 133 outputs the first distance image and the estimated three-axis polar coordinates data to the recognition unit 134. In other words, for example, the estimation unit 133 is an example of an output control unit.

When the first distance image and the estimated three-axis polar coordinates data are input from the estimation unit 133, the recognition unit 134 refers to the prediction model for skeleton recognition storage unit 122 and selects a prediction model for skeleton recognition on the basis of the estimated three-axis polar coordinates data (step S13).

The recognition unit 134 generates skeleton information indicating the posture of the person 5 who is the first subject on the basis of the first distance image using the prediction model for skeleton recognition selected by the prediction model for skeleton recognition storage unit 122 (step S14). The recognition unit 134 outputs the recognized skeleton information and an angle of each joint on the basis of the skeleton information, for example, to the display unit 111 and makes the display unit 111 display the skeleton information and the angle (step S15). As a result, the estimation device 100 can output an estimation result regarding the skeleton of the first subject and the angle of each joint. In other words, for example, the estimation device 100 provides a method for evaluating the skeleton and the angle of each joint.

In this way, the estimation device 100 acquires a first distance image including information regarding a distance from the distance sensor 10 to the person 5 who is the first subject. Furthermore, the estimation device 100 estimates three-axis polar coordinates data of the first subject from the acquired first distance image using the prediction model for posture recognition that has learned the three-axis polar coordinates data of the second subject that is the person at the time of learning the prediction model for posture recognition and the second distance image. Here, the three-axis polar coordinates data of the second subject is three-axis polar coordinates data based on a spine vector corresponding to the spine of the second subject and a shoulder vector corresponding to a line that connects both shoulders of the second subject that have been generated on the basis of coordinate data representing a position of the second subject. Furthermore, the second distance image is a distance image based on the coordinate data representing the position of the second subject and the distance from the distance sensor 10. Furthermore, the estimation device 100 estimates the posture of the person 5 on the basis of the three-axis polar coordinates data of the person 5. As a result, the estimation device 100 can output an estimation result regarding the skeleton with higher accuracy by using the prediction model for skeleton recognition created for each posture.

Furthermore, the estimation device 100 outputs data regarding the estimated posture to skeleton recognition processing for recognizing a skeleton of the first subject using a prediction model for skeleton recognition selected on the basis of the estimated posture. As a result, the estimation device 100 can recognize the skeleton using the data regarding the posture.

Furthermore, in the estimation device 100, the spine vector represents the inclined direction and the inclined amount of the second subject, and the shoulder vector represents the rotation direction of the second subject around the spine vector as an axis. As a result, the estimation device 100 can generate and use the prediction model for posture recognition that has learned data of three-axis polar coordinates expression.

### Second Embodiment

In the first embodiment described above, the skeleton recognition is performed using the estimated three-axis polar coordinates data. However, a technique (technique) may be determined by directly obtaining the number of times of somersault and the number of times of twist from the three-axis polar coordinates data, and an embodiment of this case will be described as a second embodiment. Note that, by denoting the components same as those of the estimation device 100 according to the first embodiment with the same reference numerals, description of the overlapped configuration and operation will be omitted.

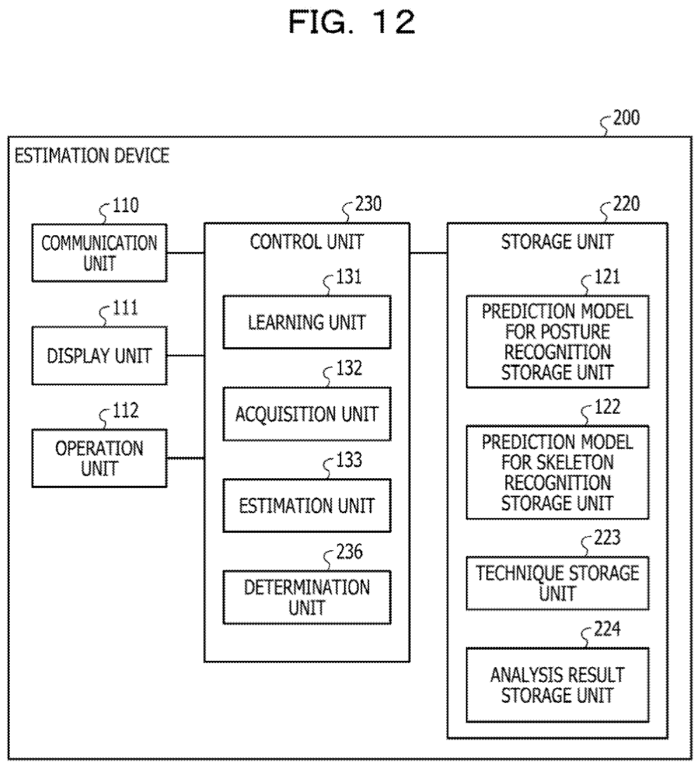

FIG. 12 is a block diagram illustrating an example of a configuration of an estimation device according to the second embodiment. An estimation device 200 illustrated in FIG. 12 includes a storage unit 220 and a control unit 230 instead of the storage unit 120 and the control unit 130 as compared with the estimation device 100 according to the first embodiment. Furthermore, the storage unit 220 includes a technique storage unit 223 and an analysis result storage unit 224 as compared with the storage unit 120. Furthermore, the control unit 230 includes a determination unit 236 instead of the recognition unit 134 as compared with the control unit 130.

The technique storage unit 223 stores the number of times of somersault and the number of times of twist in association with a technique (technique) of the gymnastics. Furthermore, the technique storage unit 223 may store the number of times of somersault, the number of times of twist, the technique of the gymnastics in association with a score.

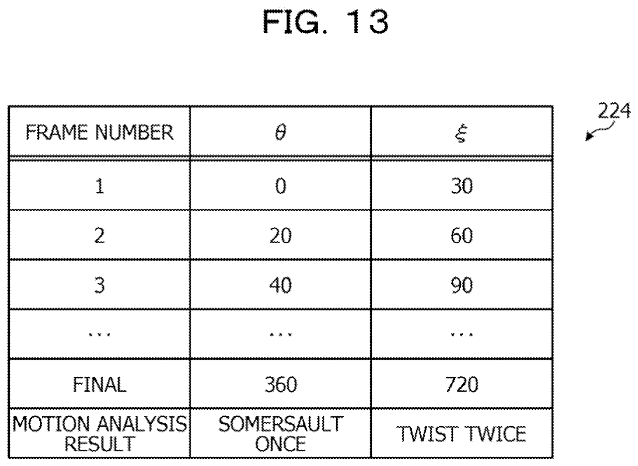

The analysis result storage unit 224 stores angles θ and ξ for each frame of a first distance image from start of a technique to end of the technique and a motion analysis result of a person 5 who is a first subject. FIG. 13 is a diagram illustrating an example of an analysis result storage unit. As illustrated in FIG. 13, the analysis result storage unit 224 includes items such as a “frame number”, “θ”, and “ξ”.

The “frame number” is information indicating a frame number of the first distance image from the start to the end of the technique. That is, for example, the first distance image is a moving image corresponding to a time from the start to the end of the technique. The item “θ” is information indicating a value of an angle θ for each frame. The item “ξ” is information indicating a value of an angle ξ for each frame. Furthermore, a row following a frame number “final” is set as “motion analysis result”, and in items “θ” and “ξ” of the row, an analysis result of the angle θ and an analysis result of the angle ξ are respectively stored. In the example in FIG. 13, an analysis result as “one somersault” based on the angle θ and an analysis result as “two twists” based on the angle ξ are stored.

Returning to the description of FIG. 12, the determination unit 236 executes the number of times of somersault determination processing and the number of times of twist determination processing in parallel according to the first distance image input from an estimation unit 133 and estimated three-axis polar coordinates data. Note that, in the second embodiment, the estimation unit 133 outputs the first distance image and the estimated three-axis polar coordinates data to the determination unit 236 for each frame of the first distance image.

As the number of times of somersault determination processing, the determination unit 236 first sets an initial value to a variable θdiff used to calculate the number of times (θdiff=0). When the first distance image and the estimated three-axis polar coordinates data (θ, φ, ξ), are input from the estimation unit 133, the determination unit 236 stores the angle θ in a θ field of a corresponding frame number of the analysis result storage unit 224 and calculates θdiff=θdiff+(θ−θpre). Note that this calculation is also expressed as θdiff+=θ−θpre. Furthermore, θ is substituted for θpre (θpre=θ). Note that an initial value of θpre is zero. That is, for example, the determination unit 236 integrates an increase of the angle θ for each one frame with θdiff.

The determination unit 236 determines whether or not θdiff exceeds 180. That is, for example, the determination unit 236 determines whether or not θdiff exceeds 180°. In a case of determining that θdiff exceeds 180, the determination unit 236 increases the number of times of somersault by 0.5 times. Furthermore, the determination unit 236 subtracts 180 from θdiff (θdiff=θdiff−180) and determines whether or not the technique ends. Note that the subtraction is also expressed as θdiff−=180. In a case of determining that θdiff does not exceed 180, the determination unit 236 determines whether or not the technique ends without increasing the number of times of somersault.

In a case of determining that the technique does not end, the determination unit 236 similarly integrates an increase of the angle θ with θdiff for the next frame in the first distance image and increases the number of times of somersault according to the determination result whether or not θdiff exceeds 180. In a case of determining that the technique ends, the determination unit 236 determines the number of times of somersault at that time as the number of times of somersault of the technique (technique) and stores the number in a θ field corresponding to the motion analysis result of the analysis result storage unit 224.

As the number of times of twist determination processing, first, the determination unit 236 seta an initial value to a variable ξdiff used to calculate the number of times (ξdiff=0). When the first distance image and the estimated three-axis polar coordinates data (θ, φ, ξ) are input from the estimation unit 133, the determination unit 236 stores the angle ξ in a ξ field of the corresponding frame number of the analysis result storage unit 224 and calculates ξdiff=ξdiff+(ξ−ξpre). Note that this calculation is also expressed as ξdiff+=ξ−ξpre. Furthermore, is substituted for ξpre (86 pre=ξ). Note that the initial value of ξpre is zero. That is, for example, the determination unit 236 integrates the increase in the angle ξ for each one frame ξdiff.

The determination unit 236 determines whether or not ξdiff exceeds 180. That is, for example, the determination unit 236 determines whether or not ξdiff exceeds 180°. In a case of determining that ξdiff exceeds 180, the determination unit 236 increases the number of times of twist by 0.5 times. Furthermore, the determination unit 236 subtracts 180 from ξdiff (ξdiff=ξdiff−180) and determines whether or not the technique ends. Note that the subtraction is also expressed as ξdiff−=180. In a case of determining that ξdiff does not exceed 180, the determination unit 236 determines whether or not the technique ends without increasing the number of times of twist.

In a case of determining that the technique does not end, the determination unit 236 similarly integrates an increase of the angle ξ with ξdiff for the next frame in the first distance image and increases the number of times of twist according to the determination result whether or not ξdiff exceeds 180. In a case of determining that the technique ends, the determination unit 236 determines the number of times of twist at that time as the number of times of twist of the technique (technique) and stores the number in a ξ field corresponding to the motion analysis result of the analysis result storage unit 224. In other words, for example, the determination unit 236 determines at least one of the number of times of somersault and the number of times of twist of the first subject on the basis of a time-series change in the estimated three-axis polar coordinates data.

The determination unit 236 refers to the technique storage unit 223 and determines a technique on the basis of the determined number of times of somersault and the determined number of times of twist. Furthermore, the determination unit 236 may acquire a score of the determined technique (technique). The determination unit 236 outputs and displays the determined technique (technique), the number of times of somersault, and the number of times of twist, for example, to and on the display unit 111. Furthermore, the determination unit 236 may output and display the determined technique (technique), the number of times of somersault, the number of times of twist, and the score to and on the display unit 111. Furthermore, the determination unit 236 may transmit the determined technique (technique), the number of times of somersault, the number of times of twist, the score, and an image of the first subject captured by a camera (not illustrated) to a terminal for a judge and display a scoring assistance screen on the terminal.

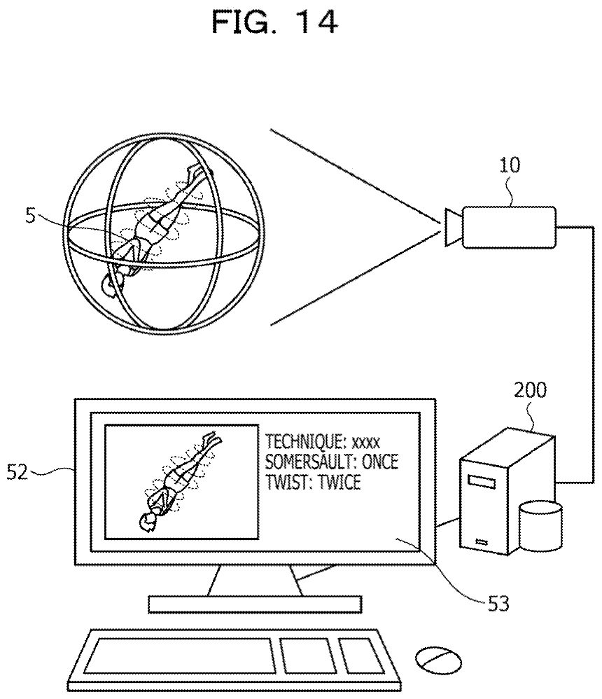

FIG. 14 is a diagram illustrating another example of the scoring assistance screen. As illustrated in FIG. 14, a terminal 52 for a judge, for example, receives a technique (technique) determined by the estimation device 200 by measuring the person 5 by the distance sensor 10, the number of times of somersault and the number of times of the twist, and an image of the person 5 who is the first subject and displays a scoring assistance screen 53. Note that a terminal 52 may display a score of the technique on the scoring assistance screen 53.

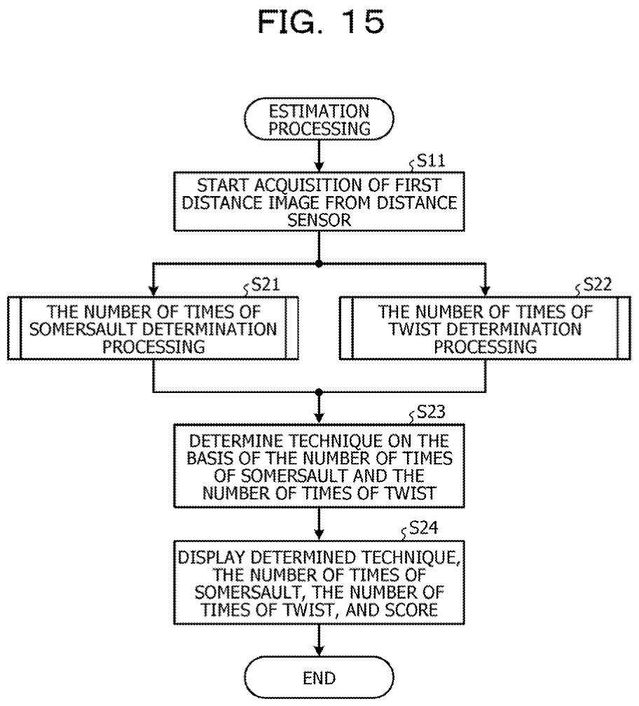

Next, an operation of the estimation device 200 according to the second embodiment will be described. Note that, because learning processing is similar to that in the first embodiment, description thereof is omitted. FIG. 15 is a flowchart illustrating an example of estimation processing according to the second embodiment. In the following description, because processing in step S11 in the estimation processing is similar to that in the first embodiment, description thereof is omitted.

The determination unit 236 of the estimation device 200 executes the following processing subsequent to the processing in step S11. The determination unit 236 executes the number of times of somersault determination processing (step S21) and the number of times of twist determination processing (step S22) in parallel according to the first distance image input from the estimation unit 133 and the estimated three-axis polar coordinates data.

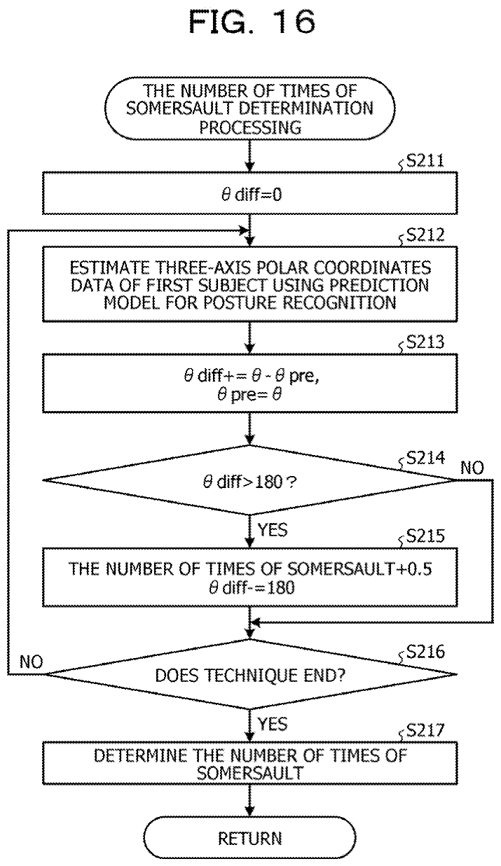

Here, the number of times of somersault determination processing will be described with reference to FIG. 16. FIG. 16 is a flowchart illustrating an example of the number of times of somersault determination processing. The determination unit 236 sets an initial value zero to θdiff (step S211). The estimation unit 133 refers to a prediction model for posture recognition storage unit 121 and estimates three-axis polar coordinates data of the person 5 who is the first subject using a prediction model for posture recognition (step S212). The estimation unit 133 outputs the first distance image and the estimated three-axis polar coordinates data to the determination unit 236.

When the first distance image and the estimated three-axis polar coordinates data (θ, φ, ξ) are input from the estimation unit 133, the determination unit 236 stores an angle θ in a θ field of a corresponding frame number of the analysis result storage unit 224 and calculates θdiff+=θ−θpre. Furthermore, θ is substituted for θpre (step S213).

The determination unit 236 determines whether or not θdiff exceeds 180 (step S214). In a case of determining that θdiff exceeds 180 (step S214: Yes), the determination unit 236 increases the number of times of somersault by 0.5 times. Furthermore, the determination unit 236 subtracts 180 from θdiff (step S215) and proceeds to step S216. In a case of determining that θdiff does not exceed 180 (step S214: No), the determination unit 236 proceeds to step S216 without increasing the number of times of somersault.

The determination unit 236 determines whether or not the technique ends (step S216). In a case of determining that the technique does not end (step S216: No), the determination unit 236 returns to step S212 and executes similar processing on the next frame of the first distance image. In a case of determining that the technique ends (step S216: Yes), the determination unit 236 determines the number of times of somersault at that time as the number of times of somersault of the technique (technique) (step S217), and returns to the original processing. As a result, the determination unit 236 can determine the number of times of somersault.

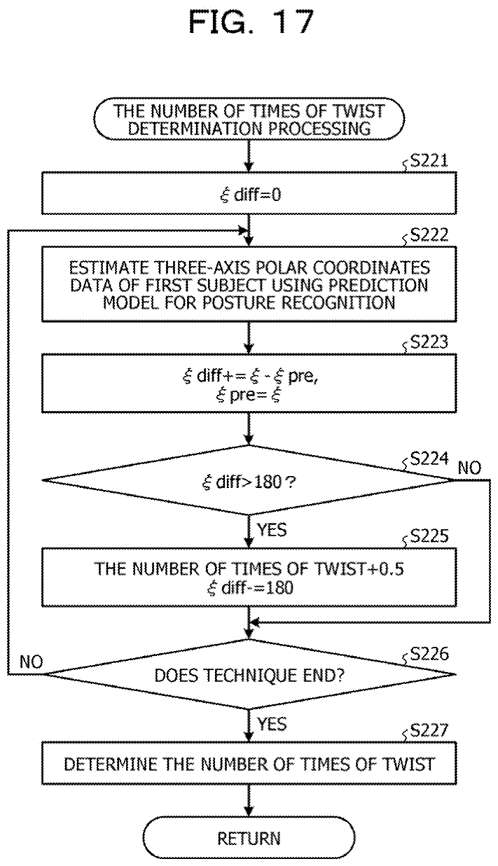

Next, the number of times of twist determination processing will be described with reference to FIG. 17. FIG. 17 is a flowchart illustrating an example of the number of times of twist determination processing. The determination unit 236 sets an initial value zero to ξdiff (step S221). The estimation unit 133 refers to the prediction model for posture recognition storage unit 121 and estimates three-axis polar coordinates data of the person 5 who is the first subject using the prediction model for posture recognition (step S222). The estimation unit 133 outputs the first distance image and the estimated three-axis polar coordinates data to the determination unit 236.

When the first distance image and the estimated three-axis polar coordinates data (θ, φ, ξ) are input from the estimation unit 133, the determination unit 236 stores an angle ξ in a ξ field of the corresponding frame number of the analysis result storage unit 224 and calculates ξdiff+=ξ−ξpre. Furthermore, ξ is substituted for ξpre (step S223).

The determination unit 236 determines whether or not ξdiff exceeds 180 (step S224). In a case of determining that ξdiff exceeds 180 (step S224: Yes), the determination unit 236 increases the number of times of twist by 0.5 times. Furthermore, the determination unit 236 subtracts 180 from ξdiff (step S225) and proceeds to step S226. In a case of determining that ξdiff does not exceed 180 (step S224: No), the determination unit 236 proceeds to step S226 without increasing the number of times of twist.

The determination unit 236 determines whether or not the technique ends (step S226). In a case of determining that the technique does not end (step S226: No), the determination unit 236 returns to step S222 and executes similar processing on the next frame of the first distance image. In a case of determining that the technique ends (step S226: Yes), the determination unit 236 determines the number of times of twist at that time as the number of times of twists of the technique (technique) (step S227), and returns to the original processing. As a result, the determination unit 236 can determine the number of times of twist.

Returning to the description of FIG. 15, the determination unit 236 refers to the technique storage unit 223 and determines a technique on the basis of the determined number of times of somersault and the determined number of times of twist (step S23). Furthermore, the determination unit 236 acquires a score of the determined technique (technique). The determination unit 236 outputs and displays the determined technique (technique), the number of times of somersault, the number of times of twist, and the score, for example, to and on the display unit 111 (step S24). As a result, the estimation device 200 can recognize the technique on the basis of the number of times of somersault and the number of times of twist.

In this way, the estimation device 200 determines at least one of the number of times of somersault and the number of times of twist of the first subject on the basis of a time-series change in the estimated three-axis polar coordinates data. As a result, the estimation device 200 can recognize the technique on the basis of the number of times of somersault and the number of times of twist.

Note that, in each of the embodiments described above, the person 5 who performs the gymnastics competition is measured, and the posture, the skeleton, and the motion are recognized. However, the present embodiment is not limited to this. For example, it can be applied to other scoring competitions such as figure skating, verification of movements during rehabilitation, analysis of forms of baseball, golf, basketball free throws, or the like, guidance assistance to new workers in line works in factories, or the like.

Furthermore, in each of the embodiments described above, a case where the number of the first subjects is one has been described. However, the present embodiment is not limited to this. For example, in a case of a plurality of persons such as basketball, women's rhythmic gymnastics groups, or the like, it is sufficient to capture a distance image by setting an angle of view that includes all the persons.

Furthermore, each of the components of each the units illustrated in the drawings does not necessarily need to be physically configured as illustrated in the drawings. In other words, for example, specific aspects of separation and integration of the respective components are not limited to the illustrated forms, and all or some of the components may be functionally or physically separated or integrated in an arbitrary unit depending on various loads, usage states, or the like. For example, the recognition unit 134 and a determination unit 135 may be integrated. Furthermore, the order of each illustrated processing is not limited to the order described above, and the processing may be concurrently executed or may be executed as changing the order in a range in which the processing content does not contradict.

Moreover, all or some of the various processing functions to be executed by each device may be executed by a CPU (or arithmetic devices such as GPU, MPU, or micro controller unit (MCU)). Furthermore, all or some of the various processing functions may of course be executed by a program to be analyzed and executed by a CPU (or arithmetic devices such as GPU, MPU, or MCU) or hardware using wired logic.

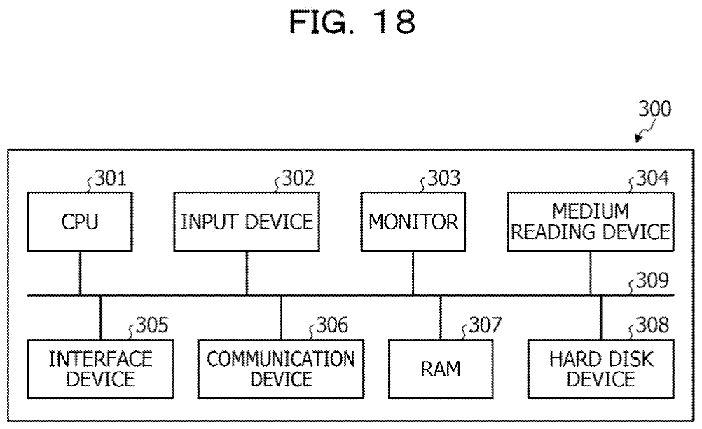

The various types of processing described in each embodiment described above can be implemented by executing a program which has been prepared in advance by a computer. Therefore, in the following, an example of the computer which executes a program having a similar function to each embodiment described above will be described. FIG. 18 is a diagram illustrating an example of the computer that executes the estimation program.

As illustrated in FIG. 18, a computer 300 includes a CPU 301 which executes various types of calculation processing, an input device 302 which receives data input, and a monitor 303. Furthermore, the computer 300 includes a medium reading device 304 which reads a program and the like from a storage medium, an interface device 305 which connects to various devices, and a communication device 306 which wiredly or wirelessly connects to the distance sensor 10, other information processing device, and the like. Furthermore, the computer 300 includes a RAM 307 which temporarily stores various types of information and a hard disk device 308. Furthermore, each of the devices 301 to 308 is connected to a bus 309.

The hard disk device 308 stores an estimation program that has a function similar to each of the processing units including the learning unit 131, the acquisition unit 132, the estimation unit 133, and the recognition unit 134 illustrated in FIG. 5. Furthermore, the hard disk device 308 stores various types of data used to implement the prediction model for posture recognition storage unit 121, the prediction model for skeleton recognition storage unit 122, and the estimation program. Furthermore, the hard disk device 308 may store an estimation program that has a function similar to each of the processing units including the learning unit 131, the acquisition unit 132, the estimation unit 133, and the determination unit 236 illustrated in FIG. 12. Furthermore, the hard disk device 308 may store various types of data used to implement the prediction model for posture recognition storage unit 121, the prediction model for skeleton recognition storage unit 122, the technique storage unit 223, the analysis result storage unit 224, and the estimation program.

For example, the input device 302 receives inputs of various types of information such as operation information from a user of the computer 300. For example, the monitor 303 displays various screens such as a display screen to the user of the computer 300. The interface device 305 is connected to, for example, a printing device or the like. For example, the communication device 306 has a function similar to the communication unit 110 illustrated in FIGS. 5 and 12, is connected to the distance sensor 10 and the other information processing device, and exchanges various types of information with the distance sensor 10 and the other information processing device.

The CPU 201 reads each program stored in the hard disk device 308 and develops and executes the program on the RAM 307 to execute various types of processing. Furthermore, these programs can make the computer 300 function as the learning unit 131, the acquisition unit 132, the estimation unit 133, the recognition unit 134 illustrated in FIG. 5. Furthermore, these programs can make the computer 300 function as the learning unit 131, the acquisition unit 132, the estimation unit 133, the determination unit 236 illustrated in FIG. 12.

Note that it is not necessary for the estimation program described above to be stored in the hard disk device 308. For example, the program stored in a storage medium which can be read by the computer 300 may be read and executed by the computer 300. The storage medium that is readable by the computer 300 corresponds to, for example, a portable recording medium such as a compact disk read only memory (CD-ROM), a digital versatile disc (DVD), or a universal serial bus (USB) memory, a semiconductor memory such as a flash memory, a hard disk drive, or the like. Alternatively, the estimation program may be prestored in a device connected to a public line, the Internet, a LAN, or the like, and the computer 300 may read the estimation program from the device so as to execute the estimation program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An estimation method in which a computer executes processing comprising:
acquiring a first distance image that includes information regarding a distance from a sensor to a first subject;
estimating three-axis polar coordinates data of the first subject from an acquired first distance image using a prediction model for posture recognition that has learned three-axis polar coordinates data based on a spine vector that corresponds to a spine of a second subject and a shoulder vector that corresponds to a line that connects both shoulders of the second subject that are generated on the basis of coordinate data that represents a position of the second subject and a second distance image based on the coordinate data of the second subject and the distance from the sensor; and
estimating a posture of the first subject on the basis of the three-axis polar coordinates data of the first subject.

2. The estimation method according to claim 1 in which the computer executes processing further comprising:
outputting data regarding an estimated posture to skeleton recognition processing that recognizes a skeleton of the first subject using a prediction model for skeleton recognition that is selected on the basis of the estimated posture.

3. The estimation method according to claim 1, in which the computer executes processing further comprising:
determining at least one of the number of times of somersault and the number of times of twist of the first subject on the basis of a time-series change of an estimated three-axis polar coordinates data.

4. The estimation method according to claim 1, wherein
the spine vector represents an inclined direction and an inclined amount of the second subject, and the shoulder vector represents a rotation direction of the second subject around the spine vector as an axis.

5. An estimation method in which a computer executes processing comprising:
acquiring a first distance image that includes information regarding a distance from a sensor to a first subject;
estimating three-axis polar coordinates data of the first subject from an acquired first distance image using a prediction model for posture recognition that has learned three-axis polar coordinates data based on a spine vector that corresponds to a spine of a second subject and a shoulder vector that corresponds to a line that connects both shoulders of the second subject that are generated on the basis of coordinate data that represents a position of the second subject and a second distance image based on the coordinate data of the second subject and the distance from the sensor; and
determining at least one of the number of times of somersault and the number of times of twist of the first subject on the basis of a time-series change of an estimated three-axis polar coordinates data.

6. A non-transitory computer-readable recording medium recording an estimation program causing a computer to execute processing comprising:
acquiring a first distance image that includes information regarding a distance from a sensor to a first subject;
estimating three-axis polar coordinates data of the first subject from an acquired first distance image using a prediction model for posture recognition that has learned three-axis polar coordinates data based on a spine vector that corresponds to a spine of a second subject and a shoulder vector that corresponds to a line that connects both shoulders of the second subject that are generated on the basis of coordinate data that represents a position of the second subject and a second distance image based on the coordinate data of second subject and the distance from the sensor; and
estimating a posture of the first subject on the basis of the three-axis polar coordinates data of the first subject.

7. The non-transitory computer-readable recording medium according to claim 6, further comprising:
outputting data regarding an estimated posture to skeleton recognition processing that recognizes a skeleton of the first subject using a prediction model for skeleton recognition that is selected on the basis of the estimated posture.

8. The non-transitory computer-readable recording medium according to claim 6, further comprising:
determining at least one of the number of times of somersault and the number of times of twist of the first subject on the basis of a time-series change of an estimated three-axis polar coordinates data.

9. The non-transitory computer-readable recording medium according to claim 6, wherein
the spine vector represents an inclined direction and an inclined amount of the second subject, and the shoulder vector represents a rotation direction of the second subject around the spine vector as an axis.
